(19) United States
(12) Patent Application Publication
(10) Pub. No.: US 2026/0247276 A1
(43) Pub. Date: Aug. 20, 2026

(54) ENERGY SAVING METHOD AND COMMUNICATION DEVICE

(71) Applicant: VIVO MOBILE COMMUNICATION CO., LTD., Dongguan (CN)

(72) Inventor: Xiaowen SUN, Dongguan (CN)

(21) Appl. No.: 19/642,667

(22) Filed: Apr. 9, 2026

Related U.S. Application Data
(63) Continuation of application No. PCT/CN2024/123454, filed on Oct. 8, 2024.

(30) Foreign Application Priority Data
Oct. 10, 2023 (CN) 202311312233.0

(51) Int. Cl. H04W 52/02; H04W 48/18; H04W 60/04

(52) U.S. Cl. CPC H04W 52/0203; H04W 48/18; H04W 60/04

(57) ABSTRACT

Provided are an energy saving method and a communication device. The energy saving method includes: receiving, by a first network function, a request message, where the request message is used to request selection of a second network function; and selecting, by the first network function, the second network function based on energy saving information.

### CROSS-REFERENCE TO RELATED APPLICATIONS

This application is a continuation of International Patent Application No. PCT/CN2024/123454, filed on October 8, 2024, which claims priority to Chinese Patent Application No. 202311312233.0, filed with China National Intellectual Property Administration on October 10, 2023 and entitled "ENERGY SAVING METHOD AND COMMUNICATION DEVICE", both of which are incorporated herein by reference in their entireties.

### TECHNICAL FIELD

This application pertains to the field of communication technology, and specifically relates to an energy saving method and a communication device.

### BACKGROUND

Service discovery (Service discovery), such as network function (Network Function, NF) service discovery, allows a service discoverer (such as a network repository function Network Repository Function, NRF) to discover a network function that provides services externally.

### SUMMARY

Embodiments of this application provide an energy saving method and a communication device.

According to a first aspect, an energy saving method is provided, including: receiving, by a first network function, a request message, where the request message is used to request selection of a second network function; and selecting, by the first network function, the second network function based on energy saving information.

According to a second aspect, an energy saving method is provided, including: sending, by a third network function, a request message, where the request message is used for the first network function to select a second network function based on energy saving information.

According to a third aspect, an energy saving apparatus is provided, including: a receiving module configured to receive a request message, where the request message is used to request selection of a second network function; and a selection module configured to select the second network function based on energy saving information.

According to a fourth aspect, an energy saving apparatus is provided, including: a sending module configured to send a request message, where the request message is used for the first network function to select a second network function based on energy saving information.

According to a fifth aspect, a communication device is provided, where the communication device includes a processor and a memory, the memory stores a program or instructions capable of running on the processor, and when the program or instructions are executed by the processor, the steps of the method according to the first aspect or the second aspect are implemented.

According to a sixth aspect, a communication device is provided, including a processor and a communication interface, where the communication interface is used to receive a request message, where the request message is used to request selection of a second network function; and the processor is configured to select the second network function based on energy saving information.

According to a seventh aspect, a communication device is provided, including a processor and a communication interface, where the communication interface is configured to send a request message, where the request message is used for the first network function to select a second network function based on energy saving information.

According to an eighth aspect, a readable storage medium is provided, where the readable storage medium stores a program or instructions, and when the program or instructions are executed by a processor, the steps of the method according to the first aspect are implemented, or the steps of the method according to the second aspect are implemented.

According to a ninth aspect, a chip is provided, where the chip includes a processor and a communication interface, the communication interface is coupled to the processor, and the processor is configured to run a program or instructions to implement the steps of the method according to the first aspect, or to implement the steps of the method according to the second aspect.

According to a tenth aspect, a computer program/program product is provided, where the computer program/program product is stored in a storage medium, and the computer program/program product is executed by at least one processor to implement the steps of the method according to the first aspect, or to implement the steps of the method according to the second aspect.

### BRIEF DESCRIPTION OF DRAWINGS

FIG. 1 is a schematic diagram of a wireless communication system according to an embodiment of this application;

FIG. 2 is a schematic flowchart of an energy saving method according to an embodiment of this application;

FIG. 3 is a schematic flowchart of an energy saving method according to an embodiment of this application;

FIG. 4 is a schematic flowchart of an energy saving method according to an embodiment of this application;

FIG. 5 is a schematic flowchart of an energy saving method according to an embodiment of this application;

FIG. 6 is a schematic flowchart of an energy saving method according to an embodiment of this application;

FIG. 7 is a schematic flowchart of an energy saving method according to an embodiment of this application;

FIG. 8 is a schematic flowchart of an energy saving method according to an embodiment of this application;

FIG. 9 is a schematic structural diagram of an energy saving apparatus according to an embodiment of this application;

FIG. 10 is a schematic structural diagram of an energy saving apparatus according to an embodiment of this application;

FIG. 11 is a schematic structural diagram of a communication device according to an embodiment of this application; and

FIG. 12 is a schematic structural diagram of a network-side device according to an embodiment of this application.

### DETAILED DESCRIPTION OF EMBODIMENTS

The following clearly describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application shall fall within the protection scope of this application.

The terms "first", "second", and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, "first" and "second" are usually used to distinguish objects of a same type, and do not restrict a quantity of objects. For example, there may be one or more first objects. In addition, "or" in this application indicates at least one of the connected objects. For example, "A or B" covers three schemes, that is, scheme 1: including A and not including B; scheme 2: including B and not including A; and scheme 3: including both A and B. The character "/" generally indicates that the associated objects before and after it are in an "or" relationship.

The term "indication" in this application can be either a direct indication (or explicit indication) or an indirect indication (or implicit indication). Direct indication can be understood as the sender explicitly informing the receiver of content such as specific information, operations to be performed, or requested results in the sent indication. Indirect indication can be understood as the receiver determining corresponding information based on the indication sent by the sender, or making judgments and determining operations to be performed, requested results, or the like based on the judgment results.

It should be noted that technologies described in the embodiments of this application are not limited to a long term evolution (Long Term Evolution, LTE) or LTE-Advanced (LTE-Advanced, LTE-A) system, and may also be applied to other wireless communication systems, for example, code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency-division multiple access (Single-carrier Frequency Division Multiple Access, SC-FDMA), and other systems. The terms "system" and "network" are often used interchangeably in the embodiments of this application. The technologies described may be used in the above-mentioned systems and radio technologies as well as other systems and radio technologies. In the following descriptions, a new radio (New Radio, NR) system is described for illustration purpose, and NR terms are used in most of the following descriptions, although these technologies may also be applied to other applications than an NR system application, for example, the 6th generation (6^{th} Generation, 6G) communication system.

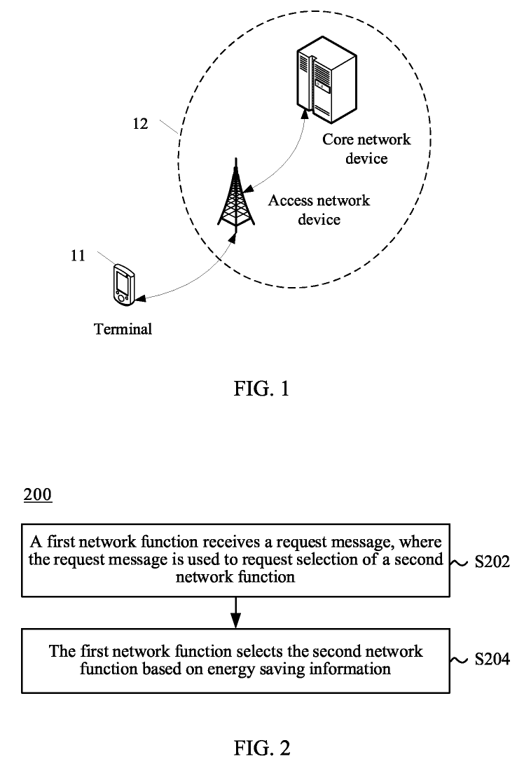

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR)/virtual reality (Virtual Reality, VR) device, a robot, a wearable device (Wearable Device), a flight vehicle (flight vehicle), a vehicle user equipment (Vehicle User Equipment, VUE), a shipborne device, a pedestrian user equipment (Pedestrian User Equipment, PUE), a smart home (home devices with wireless communication function, such as a refrigerator, a television, a washing machine, or furniture), a game console, a personal computer (Personal Computer, PC), a teller machine, or a self-service machine. The wearable device includes a smartwatch, a smart band, smart earphones, smart glasses, smart jewelry (a smart bracelet, a smart band, a smart ring, a smart necklace, a smart leglet, a smart anklet, and the like), a smart wristband, smart clothing, or the like. The vehicle user equipment may also be called an in-vehicle terminal, an in-vehicle controller, an in-vehicle module, an in-vehicle component, an in-vehicle chip, an in-vehicle unit, and the like. It should be noted that the specific type of the terminal 11 is not limited in the embodiments of this application. The network-side device 12 may include an access network device or a core network device. The access network device may also be called a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be called a Node B (Node B, NB), an evolved Node B (Evolved Node B, eNB), a next generation Node B (the next generation Node B, gNB), a new radio Node B (New Radio Node B, NR Node B), an access point, a relay base station (Relay Base Station, RBS), a serving

base station (Serving Base Station, SBS), a base transceiver station (Base Transceiver Station, BTS), a radio base station, a radio transceiver, a basic service set (Basic Service Set, BSS), an extended service set (Extended Service Set, ESS), a home Node B (home Node B, HNB), a home evolved Node B (home evolved Node B), a transmission reception point (Transmission Reception Point, TRP), or some other suitable terms in the field. As long as the same technical effect is achieved, the base station is not limited to specific technical terms. It should be noted that in the embodiments of this application, only the base station in the NR system is taken as an example for description, but the specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function unit (Policy and Charging Rules Function, PCRF), an edge application server discovery function (Edge Application Server Discovery Function, EASDF), a unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF, or L-NEF), a binding support function (Binding Support Function, BSF), an application function (Application Function, AF), and the like. It should be noted that in the embodiments of this application, only the core network device in the NR system is taken as an example for description, but the specific type of the core network device is not limited.

The following describes in detail an energy saving method according to an embodiment of this application by using some embodiments and application scenarios thereof with reference to the accompanying drawings.

As shown in FIG. 2, an embodiment of this application provides an energy saving method 200. The method may be executed by a first network function, in other words, the method may be executed by software or hardware installed in the first network function. The method includes the following steps.

S202: The first network function receives a request message, where the request message is used to request selection of a second network function.

In this embodiment, the first network function may select, based on a service request message or the like, a second network function capable of providing services externally.

Optionally, the first network function is a network repository function (NF Repository Function, NRF) or a service communication proxy (Service Communication Proxy, SCP), the request message comes from an NF service consumer (NF Service Consumer), and the second network function is an NF service producer (NF Service Producer). The NRF or the SCP may interact with the NF service producer through a service-based interface. In this embodiment, the NF service consumer may also be called an NF service consumer network element, an NF service consumer device, and the like; and the NF service producer may also be called an NF service producer network element, an NF service producer device, and the like.

Optionally, the first network function is a session management function (Session Management Function, SMF), and the second network function is a user plane function (User Plane Function, UPF). The interface between the SMF and the UPF may not be a service-based interface.

S204: The first network function selects the second network function based on energy saving information.

In this step, the first network function may select, based on energy saving information of one or more second network functions, a second network function that provides services externally.

Optionally, the request message includes an energy saving indication, where the energy saving indication is used to request selection of an energy-saving second network function, so that in S204, the first network function may select the second network function based on the energy saving indication and the energy saving information of one or more second network functions. Optionally, the energy saving indication is obtained by a third network function that sends the request message, based on the following messages: a registration message, and a protocol data unit (Protocol Data Unit, PDU) session establishment request message; or the energy saving indication is configured by the third network function for itself. In this example, the third network function that sends the request message may obtain the energy saving indication based on a registration message of a terminal or a PDU session establishment request message.

Optionally, the first network function selecting an energy-saving second network function is predefined, that is, regardless of whether the request message received by the first network function includes an energy saving indication, the first network function selects an energy-saving second network function.

In this embodiment, for example, the first network function may select a second network function in an energy-saving state; the first network function selects a second network function with an energy consumption less than or equal to a first threshold; and so on.

In related technologies, network service discovery only considers the capabilities of the second network function and its belonging network (for example, a slice, or an NPN), and the like, and does not incorporate factors such as the second network function being in different energy states (Energy State), having different energy consumptions (Energy Consumption), energy sources (Energy Source), carbon emissions (Carbon Emission), and the like. Therefore, current network service discovery does not consider energy saving factors and does not meet network architecture requirements for network energy saving.

According to the energy saving method provided in the embodiments of this application, the first network function receives a request message, where the request message is used to request selection of a second network function; and the first network function may select the second network function based on energy saving information. This facilitates selection of an energy-saving second network function, thereby meeting network architecture requirements for network energy saving.

Optionally, on the basis of any one of the above embodiments, the first network function may select the second network function based on at least one of the following energy saving information of the second network function (or in other words, the energy saving information includes at least one of the following):
(1) An energy state (Energy State), used to indicate that the second network function is in an energy-saving state (energy saving State) or a non-energy-saving state (not energy saving State). In this example, the first network function may select a second network function whose energy state is an energy-saving state. When the second network function is in the energy-saving state, another network function is required to bear the load of the second network function; when the second network function is in the non-energy-saving state, its load may continue to increase. Alternatively, when the second network function is in the energy-saving state, a network performs an operation internally based on operation administration and maintenance (Operation Administration and Maintenance, OAM), an operator operation strategy, or the like, to reduce the energy consumption of the second network function; when the second network function is in the non-energy-saving state, the network does not perform any energy saving operation or strategy.
(2) Energy consumption (Energy Consumption) information, used to indicate a total energy value consumed by the second network function or an energy value consumed by the second network function in a specific time period. The unit may be J (joule, kwH) or W (J/s). In this example, the first network function may select a second network function with an energy consumption less than or equal to a first threshold.
(3) An energy source (Energy Source), used to indicate a type of energy provided for the second network function. The type of energy may include, for example, clean energy, non-clean energy, wind energy, solar energy, thermal power, or hydropower. In this example, the first network function may select a second network function whose energy source is of a specified type, where the specified type may include, for example, clean energy, solar energy, and the like.
(4) A carbon emission (Carbon Emission), used to indicate a total carbon emission produced by the second network function or a carbon emission produced by the second network function in a specific time period. In this example, the first network function may select a second network function with a carbon emission less than or equal to a second threshold.
(5) An energy consumption indication, used to indicate whether an energy consumption of the second network function is less than or equal to a first threshold. In this example, the energy consumption indication may be "1" or "0", where "1" indicates that the energy consumption of the second network function is less than or equal to the first threshold, and "0" indicates that the energy consumption of the second network function is greater than the first threshold. The first network function may select a second network function whose energy consumption indication is "1".

Optionally, in parallel with the previous embodiment, the request message received by the first network function may include an energy saving indication, where the energy saving indication is used to request at least one of the following:

(1) selection of the second network function whose energy state is an energy-saving state;

(2) selection of the second network function with an energy consumption less than or equal to a first threshold;

(3) consideration of an energy consumption of the second network function for selecting the second network function;

(4) selection of the second network function whose energy source is of a specified type;

(5) selection of the second network function with a carbon emission less than or equal to a second threshold; and

(6) consideration of a carbon emission of the second network function for selecting the second network function.

In this embodiment, the first network function may select, based on the energy saving indication and the energy saving information of the second network function, a second network function that provides services externally.

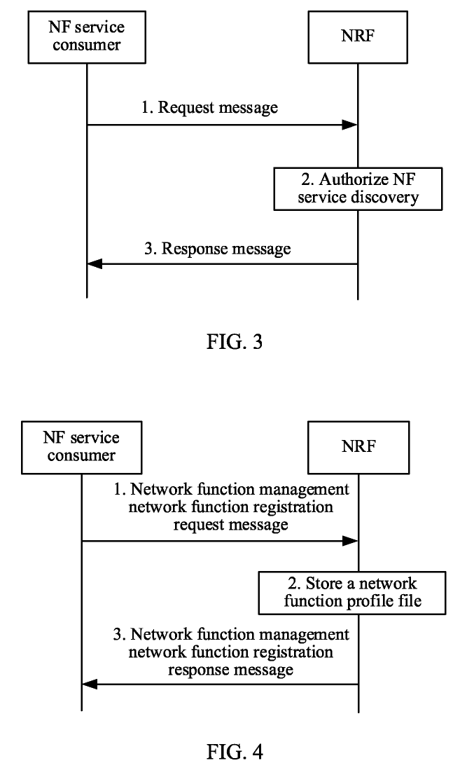

Referring to the embodiment shown in FIG. 3, this embodiment mainly describes an NF service discovery procedure, where the first network function is an NRF, the NRF receives a request message from an NF service consumer, the second network function is an NF service producer, and the NRF selects an energy-saving NF service producer for the NF service consumer. As shown in FIG. 3, this embodiment includes the following steps.

Step 1: The NF service consumer sends to the NRF a request message, such as a network function discovery request (Nnrf_NFDiscovery_Request) message.

In this embodiment, the NF service consumer expects to discover an available service in the network based on a service name and a target NF type. The NF service consumer sends an Nnrf_NFDiscovery_Request message to the NRF configured in a public land mobile network (Public Land Mobile Network, PLMN), where the Nnrf_NFDiscovery_Request message may include an expected NF service name, an NF type of an expected NF instance, and an NF type of the NF consumer, and the Nnrf_NFDiscovery_Request message may be used to request a network function profile (NF Profile) file.

An NF profile file of the NF service consumer may include the following parameters: an NF producer set ID, an NF service set ID, a subscription permanent identifier (Subscription Permanent Identifier, SUPI), a data set ID, an external group ID (UDM and UDR discovery), a UE routing indicator and home network public key identifier (UDM and AUSF discovery), single network slice selection assistance information (Single Network Slice Selection Assistance Information, S-NSSAI), an NSI ID (if available), and other service-related parameters.

Optionally, the request message may include an energy saving indication that is used for selecting a more energy-saving NF service producer and may be carried in a registration message or a PDU session establishment request, or configured by the network itself. To be specific, an operator operates an energy-saving network, requiring that all network services be provided in an energy-saving state.

Optionally, the operator-operated energy-saving network may not carry this energy saving indication, and by default, all network functions need to select the best energy-saving NF.

Step 2: The NRF authorizes NF service discovery.

Based on a profile file of an expected NF or NF service and a type of the NF service consumer, the NRF determines whether to allow the NF service consumer to discover an expected NF instance.

For the energy saving indication of the NF service consumer, the following possibilities exist:

The energy saving indication may be merely a 1-bit indication information (such as an EE indication), then the NRF selects an NF based on one or more of the following information in the NF Profile of the NF (which may be an NF service producer) registered thereto: an energy state (Energy State); an NF energy consumption (Energy Consumption); an energy source (Energy Source); and a carbon emission (Carbon Emission).

Optionally, the energy saving indication may include a specific energy saving request, for example, requesting at least one of the following:
(1) selection of an NF service producer whose energy state is an energy-saving state;
(2) selection of an NF service producer with an energy consumption less than or equal to a first threshold;
(3) consideration of an energy consumption of the NF service producer for selecting the NF service producer;
(4) selection of an NF service producer whose energy source is of a specified type;
(5) selection of an NF service producer with a carbon emission less than or equal to a second threshold; and
(6) consideration of a carbon emission of the NF service producer for selecting the NF service producer.

Step 3: The NRF sends a response message to the NF service consumer, where the response message may include, for example, a network function discovery request response message.

In this embodiment, the NRF determines a set of NF instances matching the Nnrf_NFDiscovery_Request message and the internal strategy of the NRF, and sends IDs of the determined NF instances and the like to the NF profile. Each NF profile includes at least a parameter required to be output to the NF service consumer through the network function discovery request response message.

Optionally, on the basis of the method 200, the first network function may be an NRF, the request message comes from an NF service consumer, and the second network function is an NF service producer; and the method further includes: sending, by the NRF, a service registration response message to the NF service consumer, where the service registration response message includes first information; or the first information is configured by an OAM in a service profile file of the NF service consumer; and the first information includes at least one of the following:
(1) period information, used to indicate a period or a frequency for the NF service consumer to update the service profile (NF Profile) file of the NF service consumer;
(2) an energy consumption threshold, where the energy consumption threshold is used to trigger the NF service consumer to update the service profile file of the NF service consumer;
(3) a carbon emission threshold, where the carbon emission threshold is used to trigger the NF service consumer to update the service profile file of the NF service consumer;
(4) an energy state, used to indicate that the NF service producer is in an energy-saving state or a non-energy-saving state;
(5) energy consumption information, used to indicate a total energy value consumed by the NF service producer or an energy value consumed by the NF service producer in a specific time period;
(6) an energy source, used to indicate a type of energy provided for the NF service producer;
(7) a carbon emission, used to indicate a total carbon emission produced by the NF service producer or a carbon emission produced by the NF service producer in a specific time period; and
(8) an energy consumption indication, used to indicate whether an energy consumption of the NF service producer is less than or equal to a first threshold.

Referring to the embodiment shown in FIG. 4, this embodiment mainly describes an NF service registration procedure, where the first network function is an NRF, the second network function is an NF service producer, and the NRF sends a service registration response message to an NF service consumer, where the service registration response message includes first information. As shown in FIG. 4, the following steps are included.

Step 1: The NF service consumer sends a network function management network function registration (Nnrf_NFManagement_NFRegister) request message to the NRF, and when the NF service consumer starts working for the first time, notifies the NRF of its corresponding NF Profile.

Step 2: The NRF stores an NF Profile file of the NF service consumer and marks the NF service consumer as available.

Step 3: Through a network function management network function registration response (Nnrf_NFManagement_NFRegister response) message, the NRF accepts the registration of the NF service consumer.

Optionally, the NRF has first information carried in a response message sent to the NF service consumer, where the first information includes at least one of the following:
(1) Period information, used to indicate a period or a frequency for the NF service consumer to update a service profile (NF Profile) file of the NF service consumer. For example, considering that the energy consumption of an NF (such as an NF service consumer) is constantly changing (which may be based on the EC monitoring frequency of the OAM), the core network NRF may not need to frequently update the NF energy consumption based on the OAM monitoring frequency, so it may customize the period information and report it to the NF service consumer.
(2) An energy consumption threshold, where the energy consumption threshold is used to trigger the NF service consumer to update a service profile file of the NF service consumer. The energy consumption threshold is used to define an upper limit or a lower limit of energy consumption. For an NF service update triggered by a change in energy-saving state or energy saving information, the NF service update is triggered only when the energy consumption exceeds an upper limit threshold or falls below a lower threshold.
(3) A carbon emission threshold, where the carbon emission threshold is used to trigger the NF service consumer to update a service profile file of the NF service consumer. The carbon emission threshold is used to define an upper limit or a lower limit of carbon emission. For an NF service update triggered by a change in energy-saving state or energy saving information, the NF service update is triggered only when the carbon emission exceeds an upper threshold or falls below a lower threshold.
(4) An energy state, used to indicate that the NF service producer is in an energy-saving state or a non-energy-saving state.
(5) Energy consumption information, used to indicate a total energy value consumed by the NF service producer or an energy value consumed by the NF service producer in a specific time period;
(6) An energy source, used to indicate a type of energy provided for the NF service producer.
(7) A carbon emission, used to indicate a total carbon emission produced by the NF service producer or a carbon emission produced by the NF service producer in a specific time period.
(8) An energy consumption indication, used to indicate whether an energy consumption of the NF service producer is less than or equal to a first threshold.

Optionally, the first information may alternatively be directly configured in the NF Profile of the NF service consumer by the OAM. For example, the OAM directly defines an update reporting period of the NF Profile, and the NF performs NF service update based on the period information. For another example, the OAM directly defines an energy consumption threshold or a carbon emission threshold, and the NF service update is triggered only when the energy consumption or carbon emission exceeds an upper threshold or falls below a lower threshold.

Optionally, on the basis of any one of the above embodiments, the first network function is an NRF, and the second network function is an NF service producer; and the method further includes: receiving, by the NRF, a service update message from the NF service producer, where the service update message is sent by the NF service producer when at least one of the following is satisfied: the energy state changes; the energy consumption changes; the energy source changes; the carbon emission changes; an update time defined by an update period is reached; the energy consumption reaches a configured upper threshold or lower threshold; and a carbon emission reaches a configured upper threshold or lower threshold.

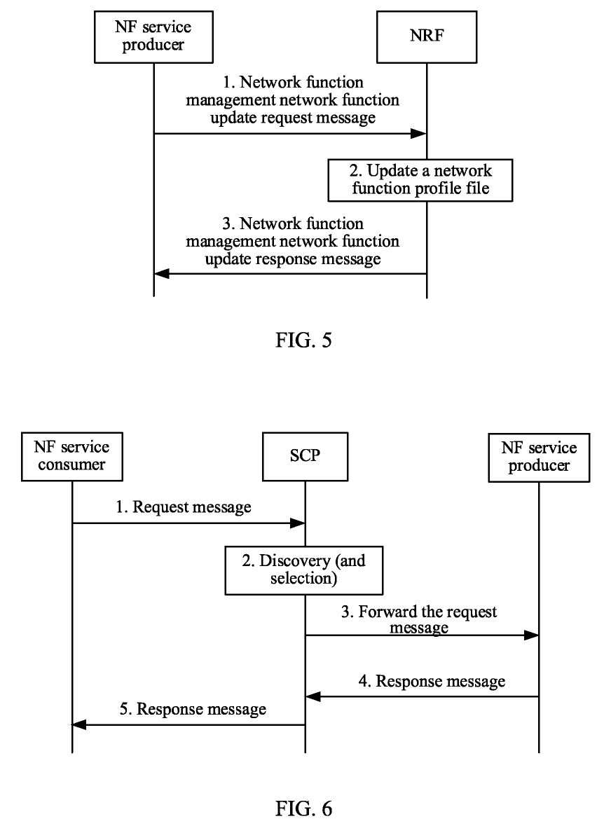

Referring to the embodiment shown in FIG. 5, this embodiment mainly describes an NF service update procedure. As shown in FIG. 5, the following steps are included.

Step 1: An NF instance (such as an NF service producer) sends a network function management network function update (Nnrf_NFManagement_NFUpdate) request message to an NRF to notify the NRF to update an NF Profile file, for example, to update an energy state, an energy consumption, an energy source, a carbon emission, or the like.

In this embodiment, the NF service producer sends a network function management network function update request message when at least one of the following conditions is satisfied: the energy state changes; the energy consumption changes; the energy source changes; the carbon emission changes; an update time defined by an update period is reached; the energy consumption reaches a configured upper threshold or lower threshold; and a carbon emission reaches a configured upper threshold or lower threshold.

Step 2: The NRF updates the NF Profile file of an NF service consumer.

Step 3: The NRF sends a network function management network function update (Nnrf_NFManagement_NFUpdate) response message to confirm the NF service update.

Optionally, in one embodiment, the first network function may be an NRF or an SCP, the request message comes from an NF service consumer, the second network function is an NF service producer, and a service profile file of the NF service consumer is updated by an OAM function based on energy saving information of the NF service producer.

Referring to the embodiment shown in FIG. 6, this embodiment mainly describes an independent NF service discovery procedure implemented through an SCP, that is, the first network function may be an SCP, the request message comes from an NF service consumer, and the second network function is an NF service producer. As shown in FIG. 6, the following steps are included.

Step 1: The NF service consumer sends a request message to the SCP, such as a service request message.

In this embodiment, the NF service consumer communicates with the NF service producer. The NF service consumer sends a service request message to the SCP. The service request message may include discovery and selection parameters required to discover and select an NF service producer instance.

The service request message may carry an energy saving indication, where the energy saving indication is used to select a more energy-saving NF service producer, and may be carried in a registration message or a PDU session establishment request message, or configured by the network itself. That is, the operator operates an energy-saving network, requiring that all network services be provided in an energy-saving state.

Optionally, the operator-operated energy-saving network may not carry this indication, and by default, all network functions need to select the best energy-saving NF.

Step 2: The SCP performs a discovery procedure.

The SCP may perform the discovery procedure by interacting with the NRF using network function discovery (Nnrf_NFDiscovery), or may use information previously collected during interaction with the NRF (through an Nnrf_NFDiscovery service or Nnrf_NFManagement_NFStatusNotify service operation). The SCP authorizes the request together with the NRF. The SCP selects a target NF service producer. During determining of the target NF service producer, for the energy saving indication of the NF service consumer, the following possibilities exist:

The energy saving indication may be merely a 1-bit indication information (such as an EE indication), then the NRF selects an NF based on one or more of the following information in the NF Profile of the NF (which may be an NF service producer) registered thereto: an energy state (Energy State); an NF energy consumption (Energy Consumption); an energy source (Energy Source); and a carbon emission (Carbon Emission).

Optionally, the energy saving indication may include a specific energy saving request, for example, requesting at least one of the following:
(1) selection of an NF service producer whose energy state is an energy-saving state;
(2) selection of an NF service producer with an energy consumption less than or equal to a first threshold;
(3) consideration of an energy consumption of the NF service producer for selecting the NF service producer;
(4) selection of an NF service producer whose energy source is of a specified type;
(5) selection of an NF service producer with a carbon emission less than or equal to a second threshold; and
(6) consideration of a carbon emission of the NF service producer for selecting the NF service producer.

Step 3: If the NF service consumer is authorized to communicate with the NF service producer, the SCP forwards the request to the selected NF service producer.

Step 4: The NF service producer sends a response message to the SCP.

Step 5: The SCP routes the response to the NF service consumer.

Optionally, in one embodiment, the first network function is a session management function (Session Management Function, SMF), and the second network function is a UPF; where the energy saving information is included in UPF provisioning information of the UPF, and the UPF provisioning information is sent by the NRF to the SMF; or the energy saving information is configured in the SMF, where the UPF is registered to the SMF through the NRF.

Optionally, the UPF provisioning information further includes at least one of the following:
(1) period information, used to indicate a period or a frequency for the UPF to update a service profile file of the UPF;
(2) an energy consumption threshold, where the energy consumption threshold is used to trigger the UPF to update a service profile file of the UPF;
(3) a carbon emission threshold, where the carbon emission threshold is used to trigger the UPF to update a service profile file of the UPF;
(4) an energy state, used to indicate that the UPF is in an energy-saving state or a non-energy-saving state;
(5) energy consumption information, used to indicate a total energy value consumed by the UPF or an energy value consumed by the UPF in a specific time period;
(6) an energy source, used to indicate a type of energy provided for the UPF;
(7) a carbon emission, used to indicate a total carbon emission produced by the UPF or a carbon emission produced by the UPF in a specific time period; and
(8) an energy consumption indication, used to indicate whether an energy consumption of the UPF is less than or equal to a first threshold.

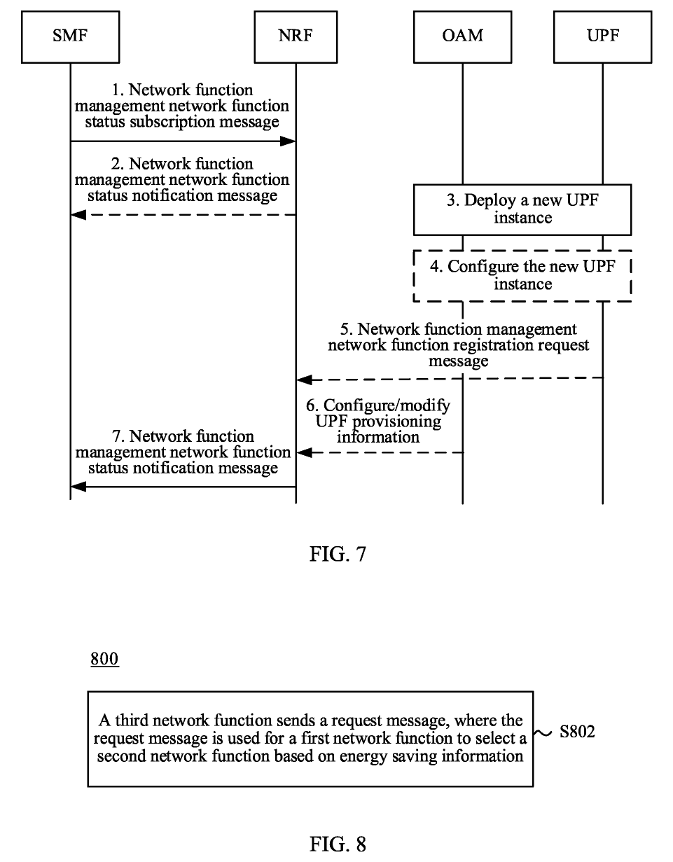

Referring to the embodiment shown in FIG. 7, in this embodiment, the UPF is registered to the SMF through the NRF. In this embodiment, to support energy saving, related description of energy saving, such as an energy state (Energy State), different energy consumptions (Energy Consumption), an energy source (Energy Source), or a carbon emission (Carbon Emission), is added to the UPF provisioning information (UPF Provisioning Information) of the UPF. Such information is added as information for the SMF to select the UPF.

Optionally, the following information may also be added to the UPF provisioning information (UPF Provisioning Information) of the UPF:
(1) Period information, used to indicate a period or a frequency for the UPF to update the UPF provisioning information of the UPF. For example, considering that the energy consumption of the UPF is constantly changing, the core network may not need to frequently update the UPF energy consumption based on the OAM monitoring frequency, so it may customize the period information.
(2) An energy consumption threshold, where the energy consumption threshold is used to trigger the UPF to update the UPF provisioning information of the UPF. The energy consumption threshold is used to define an upper limit or a lower limit of energy consumption. For a UPF provisioning information update triggered by a change in energy-saving state or energy saving information, the UPF provisioning information update is triggered only when the energy consumption exceeds an upper threshold or falls below a lower threshold.
(3) A carbon emission threshold, where the carbon emission threshold is used to trigger the UPF to update a service profile file of the UPF. The carbon emission threshold is used to define an upper limit or a lower limit of carbon emission. For a UPF provisioning information update triggered by a change in energy-saving state or energy saving information, the UPF provisioning information update is triggered only when the carbon emission exceeds an upper threshold or falls below a lower threshold.

As shown in FIG. 7, this embodiment includes the following steps.

Step 1: The SMF sends a network function management network function status subscription message to the NRF.

Step 2: The NRF sends a network function management network function status notification message to the SMF (this step is optional).

Steps 3 to 4: The OAM interacts with the UPF to perform UPF instance deployment and configuration.

Step 5: The UPF sends a network function management network function registration request message to the NRF.

Step 6: The OAM may configure or modify the UPF provisioning information of the UPF.

For example, this step is performed when the energy state of the UPF is modified; or this step is performed when the OAM detects that the energy-saving state of the UPF changes, the power consumption changes, the energy source changes, the carbon emission changes, the energy consumption/carbon emission reaches an upper limit or a lower limit of a specified threshold. For another example, this step is performed when an update time defined by an update period is reached.

Step 7: The NRF sends a network function management network function status notification message to the SMF, where the message may include energy saving description information. Reference may be made to the description of the energy saving information or energy saving indication in the previous embodiments.

Based on this step, in a UPF selection procedure, the SMF may select an appropriate UPF on demand based on the energy saving indication, the network operator strategy, or the like.

Optionally, the UPF provisioning information of the UPF may alternatively be directly configured in the SMF for use by the SMF when selecting the UPF.

The energy saving method according to the embodiments of this application has been described in detail above with reference to FIG. 2 to FIG. 7. An energy saving method according to another embodiment of this application will be described in detail below with reference to FIG. 8. It can be understood that the embodiment in FIG. 8 is the same as or corresponds to the description of the first network function side in the method shown in FIG. 2, and to avoid repetition, relevant descriptions are appropriately omitted.

FIG. 8 is a schematic flowchart of implementation of an energy saving method according to an embodiment of this application, which may be applied to a third network function. As shown in FIG. 8, the method 800 includes the following steps.

S802: The third network function sends a request message, where the request message is used for the first network function to select a second network function based on energy saving information.

In the embodiments of this application, the first network function can select an energy-saving second network function, thereby meeting network architecture requirements for network energy saving.

Optionally, in one embodiment, the first network function is an NRF or an SCP, the third network function is an NF service consumer, and the second network function is an NF service producer.

Optionally, in one embodiment, an energy saving indication is obtained by the third network function based on the following messages: a registration message, and a protocol data unit PDU session establishment request message; or the energy saving indication is configured by the third network function for itself.

Optionally, in one embodiment, the request message includes an energy saving indication, where the energy saving indication is used to request selection of an energy-saving second network function; or the first network function selecting an energy-saving second network function is predefined.

Optionally, in one embodiment, the energy saving information includes at least one of the following: (1) an energy state, used to indicate that the second network function is in an energy-saving state or a non-energy-saving state; (2) energy consumption information, used to indicate a total energy value consumed by the second network function or an energy value consumed by the second network function in a specific time period; (3) an energy source, used to indicate a type of energy provided for the second network function; (4) a carbon emission, used to indicate a total carbon emission produced by the second network function or a carbon emission produced by the second network function in a specific time period; and (5) an energy consumption indication, used to indicate whether an energy consumption of the second network function is less than or equal to a first threshold.

Optionally, in one embodiment, the energy saving indication is used to request at least one of the following: (1) selection of the second network function whose energy state is an energy-saving state; (2) selection of the second network function with an energy consumption less than or equal to a first threshold; (3) consideration of an energy consumption of the second network function for selecting the second network function; (4) selection of the second network function whose energy source is of a specified type; (5) selection of the second network function with a carbon emission less than or equal to a second threshold; and (6) consideration of a carbon emission of the second network function for selecting the second network function.

Optionally, in one embodiment, the first network function is an NRF, and the third network function is an NF service consumer; and the method further includes: receiving, by the NF service consumer, a service registration response message from the NRF, where the service registration response message includes first information; or the first information is configured by an OAM in a service profile file of the NF service consumer; and the first information includes at least one of the following: (1) period information, used to indicate a period or a frequency for the NF service consumer to update the service profile file of the NF service consumer; (2) an energy consumption threshold, where the energy consumption threshold is used to trigger the NF service consumer to update the service profile file of the NF service consumer; (3) a carbon emission threshold, where the carbon emission threshold is used to trigger the NF service consumer to update the service profile file of the NF service consumer; (4) an energy state, used to indicate that the NF service producer is in an energy-saving state or a non-energy-saving state; (5) energy consumption information, used to indicate a total energy value consumed by the NF service producer or an energy value consumed by the NF service producer in a specific time period; (6) an energy source, used to indicate a type of energy provided for the NF service producer; (7) a carbon emission, used to indicate a total carbon emission produced by the NF service producer or a carbon emission produced by the NF service producer in a specific time period; and (8) an energy consumption indication, used to indicate whether an energy consumption of the NF service producer is less than or equal to a first threshold.

Optionally, in one embodiment, the service profile file of the NF service consumer is updated by an operation administration and maintenance OAM function based on energy saving information of the NF service producer.

Optionally, in one embodiment, the first network function is an SMF, and the second network function is a UPF; where the energy saving information is included in UPF provisioning information of the UPF, and the UPF provisioning information is sent by an NRF to the SMF; or the energy saving information is configured in the SMF, where the UPF is registered to the SMF through an NRF.

Optionally, in one embodiment, the UPF provisioning information further includes at least one of the following: (1) period information, used to indicate a period or a frequency for the UPF to update a service profile file of the UPF; (2) an energy consumption threshold, where the energy consumption threshold is used to trigger the UPF to update a service profile file of the UPF; (3) a carbon emission threshold, where the carbon emission threshold is used to trigger the UPF to update a service profile file of the UPF; (4) an energy state, used to indicate that the UPF is in an energy-saving state or a non-energy-saving state; (5) energy consumption information, used to indicate a total energy value consumed by the UPF or an energy value consumed by the UPF in a specific time period; (6) an energy source, used to indicate a type of energy provided for the UPF; (7) a carbon emission, used to indicate a total carbon emission produced by the UPF or a carbon emission produced by the UPF in a specific time period; and (8) an energy consumption indication, used to indicate whether an energy consumption of the UPF is less than or equal to a first threshold.

The energy saving method according to the embodiments of this application may be executed by an energy saving apparatus. In the embodiments of this application, the energy saving apparatus executing the energy saving method is used as an example to describe an energy saving apparatus provided in an embodiment of this application.

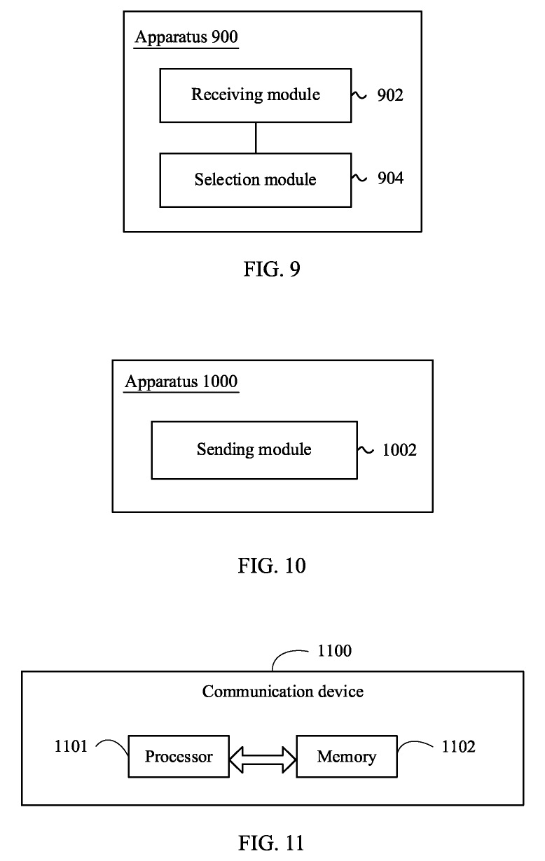

FIG. 9 is a schematic structural diagram of an energy saving apparatus according to an embodiment of this application, where the apparatus may be applied to the first network function in other embodiments. As shown in FIG. 9, the apparatus 900 includes the following modules:

a receiving module 902 configured to receive a request message, where the request message is used to request selection of a second network function; and

a selection module 904 configured to select the second network function based on energy saving information.

In the embodiment of this application, the receiving module receives a request message, where the request message is used to request selection of a second network function; and the selection module may select the second network function based on energy saving information. This facilitates selection of an energy-saving second network function, thereby meeting network architecture requirements for network energy saving.

Optionally, in one embodiment, the first network function is an NRF or an SCP, the request message comes from an NF service consumer, and the second network function is an NF service producer.

Optionally, in one embodiment, the request message includes an energy saving indication, where the energy saving indication is used to request selection of an energy-saving second network function; or the first network function selecting an energy-saving second network function is predefined.

Optionally, in one embodiment, the energy saving indication is obtained by a third network function based on the following messages: a registration message, and a protocol data unit PDU session establishment request message; or the energy saving indication is configured by a third network function for itself.

Optionally, in one embodiment, the energy saving information includes at least one of the following: (1) an energy state, used to indicate that the second network function is in an energy-saving state or a non-energy-saving state; (2) energy consumption information, used to indicate a total energy value consumed by the second network function or an energy value consumed by the second network function in a specific time period; (3) an energy source, used to indicate a type of energy provided for the second network function; (4) a carbon emission, used to indicate a total carbon emission produced by the second network function or a carbon emission produced by the second network function in a specific time period; and (5) an energy consumption indication, used to indicate whether an energy consumption of the second network function is less than or equal to a first threshold.

Optionally, in one embodiment, the energy saving indication is used to request at least one of the following: (1) selection of the second network function whose energy state is an energy-saving state; (2) selection of the second network function with an energy consumption less than or equal to a first threshold; (3) consideration of an energy consumption of the second network function for selecting the second network function; (4) selection of the second network function whose energy source is of a specified type; (5) selection of the second network function with a carbon emission less than or equal to a second threshold; and (6) consideration of a carbon emission of the second network function for selecting the second network function.

Optionally, in one embodiment, the first network function is an NRF, the request message comes from an NF service consumer, and the apparatus 900 further includes a sending module configured to send a service registration response message to the NF service consumer, where the service registration response message includes first information; or the first information is configured by an OAM in a service profile file of the NF service consumer; and the first information includes at least one of the following: (1) period information, used to indicate a period or a frequency for the NF service consumer to update the service profile file of the NF service consumer; (2) an energy consumption threshold, where the energy consumption threshold is used to trigger the NF service consumer to update the service profile file of the NF service consumer; (3) a carbon emission threshold, where the carbon emission threshold is used to trigger the NF service consumer to update the service profile file of the NF service consumer; (4) an energy state, used to indicate that the NF service producer is in an energy-saving state or a non-energy-saving state; (5) energy consumption information, used to indicate a total energy value consumed by the NF service producer or an energy value consumed by the NF service producer in a specific time period; (6) an energy source, used to indicate a type of energy provided for the NF service producer; (7) a carbon emission, used to indicate a total carbon emission produced by the NF service producer or a carbon emission produced by the NF service producer in a specific time period; and (8) an energy consumption indication, used to indicate whether an energy consumption of the NF service producer is less than or equal to a first threshold.

Optionally, in one embodiment, the first network function is an NRF, the second network function is an NF service producer, and the receiving module 902 is further configured to receive a service update message from the NF service producer, where the service update message is sent by the NF service producer when at least one of the following is satisfied: the energy state changes; the energy consumption changes; the energy source changes; the carbon emission changes; an update time defined by an update period is reached; the energy consumption reaches a configured upper threshold or lower threshold; and a carbon emission reaches a configured upper threshold or lower threshold.

Optionally, in one embodiment, the service profile file of the NF service consumer is updated by an operation administration and maintenance OAM function based on energy saving information of the NF service producer.

Optionally, in one embodiment, the first network function is an SMF, and the second network function is a UPF; where the energy saving information is included in UPF provisioning information of the UPF, and the UPF provisioning information is sent by an NRF to the SMF; or the energy saving information is configured in the SMF, where the UPF is registered to the SMF through an NRF.

Optionally, in one embodiment, the UPF provisioning information further includes at least one of the following: (1) period information, used to indicate a period or a frequency for the UPF to update a service profile file of the UPF; (2) an energy consumption threshold, where the energy consumption threshold is used to trigger the UPF to update a service profile file of the UPF; (3) a carbon emission threshold, where the carbon emission threshold is used to trigger the UPF to update a service profile file of the UPF; (4) an energy state, used to indicate that the UPF is in an energy-saving state or a non-energy-saving state; (5) energy consumption information, used to indicate a total energy value consumed by the UPF or an energy value consumed by the UPF in a specific time period; (6) an energy source, used to indicate a type of energy provided for the UPF; (7) a carbon emission, used to indicate a total carbon emission produced by the UPF or a carbon emission produced by the UPF in a specific time period; and (8) an energy consumption indication, used to indicate whether an energy consumption of the UPF is less than or equal to a first threshold.

For the apparatus 900 according to the embodiment of this application, reference may be made to the processes of the method 200 corresponding to the embodiment of this application, and each unit/module in the apparatus 900 and the above other operations and/or functions are respectively for implementing the corresponding processes in the method 200, with the same or equivalent technical effects achieved. For brevity, details are not repeated herein.

FIG. 10 is a schematic structural diagram of an energy saving apparatus according to an embodiment of this application, and the apparatus may correspond to the third network function that sends a request message in other embodiments. As shown in FIG. 10, the apparatus 1000 includes the following module.

A sending module 1002 is configured to send a request message, where the request message is used for a first network function to select a second network function based on energy saving information.

Optionally, the apparatus 1000 further includes a receiving module, and the like.

In the embodiments of this application, an energy-saving second network function can be selected, thereby meeting network architecture requirements for network energy saving.

Optionally, in one embodiment, the first network function is an NRF or an SCP, the third network function is an NF service consumer, and the second network function is an NF service producer.

Optionally, in one embodiment, the request message includes an energy saving indication, where the energy saving indication is used to request selection of an energy-saving second network function; or the first network function selecting an energy-saving second network function is predefined.

Optionally, in one embodiment, the energy saving information includes at least one of the following: (1) an energy state, used to indicate that the second network function is in an energy-saving state or a non-energy-saving state; (2) energy consumption information, used to indicate a total energy value consumed by the second network function or an energy value consumed by the second network function in a specific time period; (3) an energy source, used to indicate a type of energy provided for the second network function; (4) a carbon emission, used to indicate a total carbon emission produced by the second network function or a carbon emission produced by the second network function in a specific time period; and (5) an energy consumption indication, used to indicate whether an energy consumption of the second network function is less than or equal to a first threshold.

Optionally, in one embodiment, the energy saving indication is used to request at least one of the following: (1) selection of the second network function whose energy state is an energy-saving state; (2) selection of the second network function with an energy consumption less than or equal to a first threshold; (3) consideration of an energy consumption of the second network function for selecting the second network function; (4) selection of the second network function whose energy source is of a specified type; (5) selection of the second network function with a carbon emission less than or equal to a second threshold; and (6) consideration of a carbon emission of the second network function for selecting the second network function.

Optionally, in one embodiment, the first network function is an NRF, the third network function is an NF service consumer, and the apparatus 1000 further includes a receiving module configured to receive a service registration response message from the NRF, where the service registration response message includes first information; or the first information is configured by an OAM in a service profile file of the NF service consumer; and the first information includes at least one of the following: (1) period information, used to indicate a period or a frequency for the NF service consumer to update the service profile file of the NF service consumer; (2) an energy consumption threshold, where the energy consumption threshold is used to trigger the NF service consumer to update the service profile file of the NF service consumer; (3) a carbon emission threshold, where the carbon emission threshold is used to trigger the NF service consumer to update the service profile file of the NF service consumer; (4) an energy state, used to indicate that the NF service producer is in an energy-saving state or a non-energy-saving state; (5) energy consumption information, used to indicate a total energy value consumed by the NF service producer or an energy value consumed by the NF service producer in a specific time period; (6) an energy source, used to indicate a type of energy provided for the NF service producer; (7) a carbon emission, used to indicate a total carbon emission produced by the NF service producer or a carbon emission produced by the NF service producer in a specific time period; and (8) an energy consumption indication, used to indicate whether an energy consumption of the NF service producer is less than or equal to a first threshold.

Optionally, in one embodiment, the service profile file of the NF service consumer is updated by an OAM function based on energy saving information of the NF service producer.

Optionally, in one embodiment, the first network function is an SMF, and the second network function is a UPF; where the energy saving information is included in UPF provisioning information of the UPF, and the UPF provisioning information is sent by an NRF to the SMF; or the energy saving information is configured in the SMF, where the UPF is registered to the SMF through an NRF.

Optionally, in one embodiment, the UPF provisioning information further includes at least one of the following: (1) period information, used to indicate a period or a frequency for the UPF to update a service profile file of the UPF; (2) an energy consumption threshold, where the energy consumption threshold is used to trigger the UPF to update a service profile file of the UPF; (3) a carbon emission threshold, where the carbon emission threshold is used to trigger the UPF to update a service profile file of the UPF; (4) an energy state, used to indicate that the UPF is in an energy-saving state or a non-energy-saving state; (5) energy consumption information, used to indicate a total energy value consumed by the UPF or an energy value consumed by the UPF in a specific time period; (6) an energy source, used to indicate a type of energy provided for the UPF; (7) a carbon emission, used to indicate a total carbon emission produced by the UPF or a carbon emission produced by the UPF in a specific time period; and (8) an energy consumption indication, used to indicate whether an energy consumption of the UPF is less than or equal to a first threshold.

For the apparatus 1000 according to the embodiment of this application, reference may be made to the processes of the method 800 corresponding to the embodiment of this application, and each unit/module in the apparatus 1000 and the above other operations and/or functions are respectively for implementing the corresponding processes in the method 800, with the same or equivalent technical effects achieved. For brevity, details are not repeated herein.

Optionally, as shown in FIG. 11, an embodiment of this application further provides a communication device 1100 including a processor 1101 and a memory 1102. The memory 1102 stores a program or instructions capable of running on the processor 1101. For example, in a case that the communication device 1100 is a network-side device, when the program or instructions are executed by the processor 1101, the steps of the foregoing energy saving method embodiments are implemented, with the same technical effects achieved. To avoid repetition, details are not described herein again.

An embodiment of this application further provides a network-side device including a processor and a communication interface. The communication interface is configured to receive a request message, where the request message is used to request selection of a second network function; and the processor is configured to select the second network function based on energy saving information. Alternatively, the communication interface is configured to send a request message, where the request message is used for a first network function to select a second network function based on energy saving information. This network-side device embodiment corresponds to the above network-side device method embodiment, and the implementation processes and implementations of the above method embodiment may be applied to this network-side device embodiment, with the same technical effects achieved.

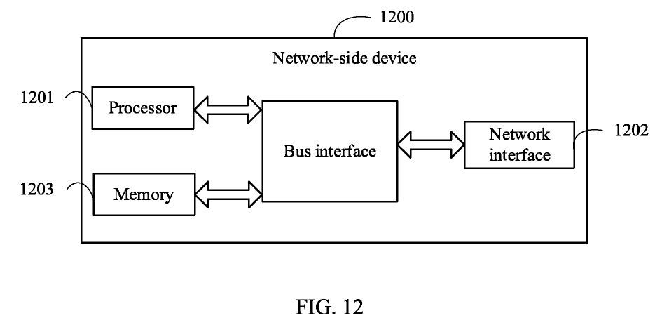

An embodiment of this application further provides a network-side device. As shown in FIG. 12, the network-side device 1200 includes: a processor 1201, a network interface 1202, and a memory 1203. The network interface 1202 is, for example, a common public radio interface (Common Public Radio Interface, CPRI).

Specifically, the network-side device 1200 in the embodiment of this application further includes: instructions or a program stored on the memory 1203 and capable of running on the processor 1201. The processor 1201 calls the instructions or program in the memory 1203 to execute the methods executed by the modules shown in FIG. 9 or FIG. 10, with the same technical effects achieved. To avoid repetition, details are not described herein again.

An embodiment of this application further provides a readable storage medium, where the readable storage medium stores a program or instructions, and when the program or instructions are executed by a processor, each process of the foregoing energy saving method embodiments is implemented, with the same technical effects achieved. To avoid repetition, details are not described herein again.

The processor is the processor in the terminal described in the foregoing embodiments. The readable storage medium may be non-volatile or non-transitory. The readable storage medium includes a computer readable storage medium, such as a computer read-only memory ROM, a random access memory RAM, a magnetic disk, or a compact disc. In some examples, the readable storage medium may be a non-transitory readable storage medium.

An embodiment of this application further provides a chip, where the chip includes a processor and a communication interface, the communication interface is coupled to the processor, and the processor is configured to run a program or instructions to implement each process of the foregoing energy saving method embodiments, with the same technical effects achieved. To avoid repetition, details are not described herein again.

It should be understood that the chip mentioned in the embodiments of this application may also be called a system-level chip, a system chip, a chip system, a system on chip, or the like.

An embodiment of this application further provides a computer program/program product, where the computer program/program product is stored in a storage medium, and the computer program/program product is executed by at least one processor to implement each process of the foregoing energy saving method embodiments, with the same technical effects achieved. To avoid repetition, details are not described herein again.

An embodiment of this application further provides an energy saving system including: a terminal and a network-side device, where the terminal may be configured to performed the steps of the energy saving methods described above, and the network-side device may be configured to perform the steps of the energy saving methods described above.

It should be noted that in this specification, the terms "include" and "comprise", or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by "includes a…" does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

Through the description of the above embodiments, those skilled in the art can clearly understand that the methods of the above embodiments may be implemented by means of software plus a necessary general hardware platform, and of course, may also be implemented by hardware. The computer software product is stored in a storage medium (such as a ROM, a RAM, a magnetic disk, or a compact disc), including several instructions to make a terminal or a network-side device execute the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As inspired by this application, a person of ordinary skill in the art may develop many other implementations without departing from principles of this application and the protection scope of the claims, and all such implementations shall fall within the protection scope of this application.

What is claimed is:

1. An energy saving method, comprising:
receiving, by a first network function, a request message, wherein the request message is used to request selection of a second network function; and
selecting, by the first network function, the second network function based on energy saving information.

2. The method according to claim 1, wherein
the request message comprises an energy saving indication, wherein the energy saving indication is used to request selection of the energy-saving second network function; or
the first network function selecting the energy-saving second network function is predefined.

3. The method according to claim 1, wherein the energy saving information comprises at least one of the following:
an energy state, used to indicate that the second network function is in an energy-saving state or a non-energy-saving state;
energy consumption information, used to indicate a total energy value consumed by the second network function or an energy value consumed by the second network function in a specific time period;
an energy source, used to indicate a type of energy provided for the second network function;
a carbon emission, used to indicate a total carbon emission produced by the second network function or a carbon emission produced by the second network function in a specific time period; or
an energy consumption indication, used to indicate whether an energy consumption of the second network function is less than or equal to a first threshold.

4. The method according to claim 2, wherein the energy saving indication is used to request at least one of the following:
selection of the second network function whose energy state is an energy-saving state;
selection of the second network function with an energy consumption less than or equal to a first threshold;
consideration of an energy consumption of the second network function for selecting the second network function;
selection of the second network function whose energy source is of a specified type;
selection of the second network function with a carbon emission less than or equal to a second threshold; or
consideration of a carbon emission of the second network function for selecting the second network function.

5. The method according to claim 1, wherein
the first network function is a network repository function NRF or a service communication proxy SCP, the request message comes from an NF service consumer, and the second network function is an NF service producer.

6. The method according to claim 1, wherein the first network function is an NRF, and the request message comes from an NF service consumer; the method further comprises: sending, by the NRF, a service registration response message to the NF service consumer, wherein the service registration response message comprises first information; or the first information is configured by an operation administration and maintenance OAM in a service profile file of the NF service consumer; and the first information comprises at least one of the following:
period information, used to indicate a period or a frequency for the NF service consumer to update the service profile file of the NF service consumer;
an energy consumption threshold, wherein the energy consumption threshold is used to trigger the NF service consumer to update the service profile file of the NF service consumer;
a carbon emission threshold, wherein the carbon emission threshold is used to trigger the NF service consumer to update the service profile file of the NF service consumer;
an energy state, used to indicate that the NF service producer is in an energy-saving state or a non-energy-saving state;
energy consumption information, used to indicate a total energy value consumed by the NF service producer or an energy value consumed by the NF service producer in a specific time period;
an energy source, used to indicate a type of energy provided for the NF service producer;
a carbon emission, used to indicate a total carbon emission produced by the NF service producer or a carbon emission produced by the NF service producer in a specific time period; or
an energy consumption indication, used to indicate whether an energy consumption of the NF service producer is less than or equal to a first threshold.

7. The method according to claim 1, wherein the first network function is an NRF, and the second network function is an NF service producer; and the method further comprises: receiving, by the NRF, a service update message from the NF service producer, wherein the service update message is sent by the NF service producer when at least one of the following is satisfied:
the energy state changes; the energy consumption changes; the energy source changes; the carbon emission changes; an update time defined by an update period is reached; the energy consumption reaches a configured upper threshold or lower threshold; or a carbon emission reaches a configured upper threshold or lower threshold.

8. The method according to claim 5, wherein a service profile file of the NF service consumer is updated by an operation administration and maintenance OAM function based on energy saving information of the NF service producer.

9. The method according to claim 1, wherein the first network function is a session management function SMF, and the second network function is a UPF; wherein
the energy saving information is comprised in UPF provisioning information of the UPF, and the UPF provisioning information is sent by an NRF to the SMF; or
the energy saving information is configured in the SMF, wherein the UPF is registered to the SMF through an NRF.

10. The method according to claim 9, wherein the UPF provisioning information further comprises at least one of the following:
period information, used to indicate a period or a frequency for the UPF to update a service profile file of the UPF;
an energy consumption threshold, wherein the energy consumption threshold is used to trigger the UPF to update a service profile file of the UPF;
a carbon emission threshold, wherein the carbon emission threshold is used to trigger the UPF to update a service profile file of the UPF;
an energy state, used to indicate that the UPF is in an energy-saving state or a non-energy-saving state;
energy consumption information, used to indicate a total energy value consumed by the UPF or an energy value consumed by the UPF in a specific time period;
an energy source, used to indicate a type of energy provided for the UPF;
a carbon emission, used to indicate a total carbon emission produced by the UPF or a carbon emission produced by the UPF in a specific time period; or
an energy consumption indication, used to indicate whether an energy consumption of the UPF is less than or equal to a first threshold.

11. An energy saving method, comprising:
sending, by a third network function, a request message, wherein the request message is used for a first network function to select a second network function based on energy saving information.

12. The method according to claim 11, wherein
the request message comprises an energy saving indication, wherein the energy saving indication is used to request selection of the energy-saving second network function; or
the first network function selecting the energy-saving second network function is predefined.

13. The method according to claim 12, wherein
the energy saving indication is obtained by the third network function based on the following messages: a registration message, a protocol data unit PDU session establishment request message; or
the energy saving indication is configured by the third network function for itself.

14. The method according to claim 11, wherein the energy saving information comprises at least one of the following:
an energy state, used to indicate that the second network function is in an energy-saving state or a non-energy-saving state;
energy consumption information, used to indicate a total energy value consumed by the second network function or an energy value consumed by the second network function in a specific time period;
an energy source, used to indicate a type of energy provided for the second network function;
a carbon emission, used to indicate a total carbon emission produced by the second network function or a carbon emission produced by the second network function in a specific time period; or
an energy consumption indication, used to indicate whether an energy consumption of the second network function is less than or equal to a first threshold.

15. The method according to claim 12, wherein the energy saving indication is used to request at least one of the following:
selection of the second network function whose energy state is an energy-saving state;
selection of the second network function with an energy consumption less than or equal to a first threshold;
consideration of an energy consumption of the second network function for selecting the second network function;
selection of the second network function whose energy source is of a specified type;
selection of the second network function with a carbon emission less than or equal to a second threshold; or
consideration of a carbon emission of the second network function for selecting the second network function.

16. The method according to claim 11, wherein
the first network function is an NRF or an SCP, the third network function is an NF service consumer, and the second network function is an NF service producer.

17. The method according to claim 11, wherein the first network function is an NRF, and the third network function is an NF service consumer; and the method further comprises: receiving, by the NF service consumer, a service registration response message from the NRF, wherein the service registration response message comprises first information; or the first information is configured by an OAM in a service profile file of the NF service consumer; and the first information comprises at least one of the following:
period information, used to indicate a period or a frequency for the NF service consumer to update the service profile file of the NF service consumer;
an energy consumption threshold, wherein the energy consumption threshold is used to trigger the NF service consumer to update the service profile file of the NF service consumer;
a carbon emission threshold, wherein the carbon emission threshold is used to trigger the NF service consumer to update the service profile file of the NF service consumer;
an energy state, used to indicate that the NF service producer is in an energy-saving state or a non-energy-saving state;
energy consumption information, used to indicate a total energy value consumed by the NF service producer or an energy value consumed by the NF service producer in a specific time period;
an energy source, used to indicate a type of energy provided for the NF service producer;
a carbon emission, used to indicate a total carbon emission produced by the NF service producer or a carbon emission produced by the NF service producer in a specific time period; or
an energy consumption indication, used to indicate whether an energy consumption of the NF service producer is less than or equal to a first threshold.

18. The method according to claim 16, wherein a service profile file of the NF service consumer is updated by an operation administration and maintenance OAM function based on energy saving information of the NF service producer.

19. A communication device, comprising a processor and a memory, wherein the memory stores a program or instructions capable of running on the processor, and when the program or instructions are executed by the processor, an energy saving method is implemented, the method comprising:
receiving a request message, wherein the request message is used to request selection of a second network function; and
selecting the second network function based on energy saving information.

20. A communication device, comprising a processor and a memory, wherein the memory stores a program or instructions capable of running on the processor, and when the program or instructions are executed by the processor, the method according to claim 11 is implemented.
